(19) United States
(12) Patent Application Publication
(10) Pub. No.: US 2017/0270541 A1
(43) Pub. Date: Sep. 21, 2017

(54) System and Method for Monetizing Internet Traffic Related to a Property Value Inquiry

(71) Applicant: Vicuna Leads, LLC, Jupiter, FL (US)

(72) Inventor: Timothy James Allen, JR., Jupiter, FL (US)

(21) Appl. No.: 15/460,322

(22) Filed: Mar. 16, 2017

Related U.S. Application Data
(60) Provisional application No. 62/309,364, filed on Mar. 16, 2016.

(51) Int. Cl. G06Q 30/02; G06Q 50/16

(52) U.S. Cl. CPC G06Q 30/0201; G06Q 50/16

(57) ABSTRACT

A system and method are provided for monetizing a property value inquiry related to a property identifier submitted by a user along with personal information of the user. The personal information and property identifier submitted by the user are used by the system to generate a lead that is marketable to lenders or other service providers. Promotional information of the lender or other service provider is displayed to the user in a pop-under or a pop-after browser window. The system promotes loans or other services to consumers via such online advertisements directed to consumers seeking information related to property values. The system includes processes for inputting the user's personal information, generating a property value report that is specific to the property identifier, and promoting certain lenders or services providers to the user based on the personal information input into the system by the user.

### CROSS-REFERENCE TO RELATED APPLICATIONS

This application is a nonprovisional application of and claims priority from U.S. provisional patent application Ser. No. 62/309,364 filed on Mar. 16, 2016. The foregoing application is incorporated in its entirety herein by reference.

### FIELD OF THE INVENTION

The invention relates to systems and methods for monetizing a property value inquiry. More particularly, the invention relates to systems and methods for monetizing a home or other property value inquiry by collecting a user's personal information and property identifier, in exchange for a property value report, to generate a lead. Related services, e.g., mortgages, other loans, or other services, are promoted to the user by selling the lead to lenders or other services providers and via online advertisements directed to the user seeking information related to a property value (and in particular, a home value).

### BACKGROUND

With an ever-increasing amount of real estate-related business conducted via the Internet, the real estate industry, including real estate brokers, agents, and listing services, have sought ways to profit from leads generated by consumers who view property listings on websites. One manner of monetizing such leads is to provide to a consumer a listing of mortgage lenders and their current rates or other service providers and their prices based on information that the consumer inputs into data entry fields on a website seeking information concerning desired loan amount, term, potential borrower's income, and whether the loan is for a purchase or refinance. Other websites may offer online “wizards” or calculators to provide certain financial calculations related to a home purchase that the user may be seeking. After entering the foregoing items of information, the user is generally provided with a list of mortgage lenders and their rates in the same browser window that the user opened to access the website initially. On some websites, a loan amortization schedule may also be provided. Such systems are ineffective in generating quality leads because they fail to collect any personal information (e.g., name and contact information) of the user. Moreover, these conventional systems and methods do not provide any incentive for a user to provide such personal information. The user may also close the window once the user views the information that he or she was seeking. Once the user closes the window containing contact information for a mortgage lender or links to the mortgage lender's website, the value of the lead is diminished.

A need exists for systems and methods that incentivize users to provide personal information that can be converted to leads for mortgage lenders and other home-related or property-related service providers. A need also exists for increasing the likelihood both that the user notices the mortgage lender or service provider's contact information and offer of services and that the user contacts the mortgage lender or service provider for rates or pricing.

### SUMMARY

The invention relates to systems and methods for promoting loans to consumers via online advertisements directed to consumers seeking information related to home values and for monetizing the Internet traffic of those consumers as lending leads for purchase from the advertiser or service provider by lenders. The system includes processes for inputting a user's personal information, generating a property value report that is specific to the property in which the user is interested, and promoting certain lenders or services of certain service providers to the user based on the personal information input into the system by the user. The promotional information of the lender or other service provider is displayed to the user in a pop-under or a pop-after browser window. For example, the promotional information can include a link to a mortgage lender's website, which can include an online mortgage application or a telephone number that the user can call to telephonically submit a mortgage application. If the user does not utilize the promotional information to contact the lender or service provider, the system has already obtained the user-submitted personal information that the system's operator may sell as a lead to one or more mortgage lenders or services providers.

While the systems and methods described herein are useful for generating leads for mortgage lenders, they may also be used to generate leads for other service providers such as, for example, homeowner's insurance providers, home repair companies, interior decorators, appraisers, home construction contractors and remodelers, and other service providers that provide services related to homes or other property.

The systems and methods described herein are advantageous in that leads are generated that capture the personal information of users, who are potential borrowers, including the users' names, e-mail addresses, mailing addresses, and phone numbers. The users' personal incomes and other financial information related to each user may also be obtained by the system in exchange for providing the user with a property value report that details information concerning a present value of the property. Another advantage of the systems and methods described herein is that users are more likely to notice and react to the promotions of the service providers (e.g., list of mortgage lenders and their respective interest rates) because the rate information and links to each lender's online mortgage application are included in pop-under windows or pop-after windows that are open in separate browser windows for viewing after the user closes or minimizes the browser window in which the system was first accessed via the website. By presenting the list of lenders and their rates in a separate browser window that opens “behind” or “under” the browser window that the user views to access the website, or in a separate browser window that opens after the user closes or minimizes the browser window in which the user accesses and views the website, the user is presented with lender (or other service provider) options and promotions based on information provided by the user and in a manner that is not as obtrusive and less annoying to the user than the ubiquitous pop-up advertisements that permeate the Internet.

Accordingly, the invention features a system for generating and monetizing a lead based on a value inquiry. The system includes a user information collection process that includes a website for receiving personal information and a property identifier submitted by the user. The personal information and property identifier submitted through the user information collection process by the user is used to create a lead based on a value inquiry related to the property identifier submitted by the user. The lead includes the personal information and property identifier submitted by the user through the user information collection process. The system further includes a property value report engine for generating a property value report related to the property identifier submitted by the user, and a window generator script for generating a new window that is a pop-under window or a pop-after window in an open Internet browser. The new window includes a list of service providers and contact information for each service provider. The lead is marketable for sale to a service provider that is one of the service providers on the list of service providers or a different service provider.

In another aspect, the invention can feature the property identifier being a property address, a property legal description, a property's GPS coordinates, a make and model of an automobile, or any other information that identifies the property for which the user is seeking a property value report.

In another aspect, the invention can feature the new window including a different window open in the Internet browser than the window in which the website is displayed.

In another aspect, the invention can feature the service providers being mortgage lenders.

In another aspect, the invention can feature the new window displaying prices or rates for each service provider.

In another aspect, the invention can feature the service providers being mortgage lenders, and the rates being mortgage interest rates of the mortgage lenders.

In another aspect, the invention can feature the personal information including the user's name and at least one other item of personal information of the user selected from among: a mailing address, a telephone number, or an e-mail address.

In another aspect, the invention can feature the at least one other item of personal information including the user's e-mail address. The property value report engine transmits a copy of the property value report related to the property identifier submitted by the user to the user's e-mail address.

The invention also features a system for monetizing Internet traffic related to a property value inquiry. The system includes a website, which includes property fields for entry by a user of a property address and a property type and a financial field in which the user selects between buy, sell, or refinance options. The website also includes personal fields in which name and contact information for the user are entered and a submit button on the website for submitting the user's data entries in the property, financial, and personal fields to a server that uses the data entries to generate a lead. The lead includes the data entries submitted by the user. The system further includes a database on the server for storing the information received from the user. The system also includes an automated report module for generating a property value report for the property address provided by the user through the website and for sending a copy of the property value report to the user via an e-mail to the user's e-mail address provided by the user as contact information in the personal fields. The system also includes a window generator script for generating a new window. The new window can be a pop-under window or a pop-after window in an open Internet browser. The new window includes a list of one or more mortgage lenders, rates for each lender, and contact information for each lender. The lead is offered for sale to the one or more mortgage lenders or to other mortgage lenders not included in the list.

In another aspect, the invention can feature the new window being a different window open in the Internet browser than the window in which the website is displayed.

In another aspect, the invention can feature the contact information for each lender being a phone number to complete a telephonic mortgage application. The user's call to the phone number provided for a particular lender in the new window is a lead tracked by the system so that an operator of the system is paid by the mortgage lenders for such leads.

In another aspect, the invention can feature the contact information for each lender being a link to a second website that includes an online mortgage application. The user's accessing the link provided for a particular lender in the new window is a lead tracked by the system so that an operator of the system is paid by the mortgage lenders for such leads.

In another aspect, the invention can feature the property type being a property type selected from among: a single family home, a condominium, a townhome, a cooperative housing unit, a duplex, a timeshare, a commercial building, and raw land. The property type can further include a user selection that identifies the property value inquiry as relating to the user's desire to purchase, refinance, or rent the property

A method of the invention can be used for generating a lead. The method includes the step of: (a) providing a website for receiving and transmitting data entries provided by a user. The website includes property fields for entry by the user of a property identifier and a property type. The website also includes a financial field in which the user selects between buy, sell, or refinance options. The website further includes personal fields in which name and contact information for the user are entered. The method also includes the steps of: (b) inputting of a user-selected property identifier and property type in the property fields, an option in the financial field, and the user's name and contact information in the personal fields; (c) submitting the user's data entries to a remote server for storage on a database located on the remote server, wherein the data entries are used by the server to generate a lead that is marketable for sale to a service provider; (d) using an automated report module, generating a property value report for the property identifier provided by the user through the website; (e) transmitting a copy of the property value report to the user via an e-mail to the user's e-mail address provided by the user as contact information in the personal fields; and (f) using a window generator script, generating a new window that is a pop-under window or a pop-after window in an open Internet browser, wherein the new window includes a name of at least one service provider, which can include the service provider or one or more different service providers, and contact information for each service provider.

Another method of the invention can include the at least one service provider being at least mortgage lender.

Another method of the invention can include the new window displaying prices or rates for each at least one service provider.

Another method of the invention can include the service providers being mortgage lenders and the rates being mortgage interest rates of the mortgage lenders.

Another method of the invention can include the contact information for the at least one service provider being a link to a second website. The method can further include the steps of: (g) accessing the link to be directed to the second website; and (h) requesting a quote from the at least one service provider.

Another method of the invention can include the at least one service provider being at least one mortgage lender and step (h) including the step of completing an online mortgage application.

Another method of the invention can include the property identifier being a property address, a property legal description, a property's GPS coordinates, a make and model of an automobile, or any other information that identifies the property for which the user is seeking a value report.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The invention provides systems and methods for promoting loans to consumers via online advertisements directed to consumers seeking information related to home values and for monetizing the Internet traffic of those consumers as lending leads for purchase from the advertiser or service provider by lenders. Leads are generated in two ways. First, the system collects personal information related to specific user in exchange for providing a property value report (e.g., a home value report), which lead can be marketed and sold to one or more lenders. Second, the system also uses pop-under or pop-after windows containing a list of lenders and their rates that are displayed in a separate browser window (i.e., the pop-under or pop-after window) to the user so that the user may contact one of the listed lenders to apply for a mortgage or other loan. The system tracks a user's contact of the lender using the phone number or web address link provided in the list so that the operator of the system may be paid for the lead that originated on the system website. The rates for each lender in the list (or prices of services for each service provider in the list in cases where the service providers are not lenders) can be determined based on the personal information submitted by the user, which can include the user's financial information, e.g., annual personal income.

The systems and methods include a website that provides a procedure having steps for inputting certain information in order to obtain an estimated home value. The home can be a single-family home, a condominium, a townhome, a unit in a cooperative, a mobile home, or any other type of home. In another embodiment, the systems and methods can also allow property value inquiries to be performed by the user in relation to vacant land. While the examples described herein relate to residential properties, the systems and methods can also be used for commercial properties or raw or vacant land. The website may provide a single web page or multiple web pages for the input of this data by a user. Such data can include a specific address of specific property or more generalized location information such as a city, state, ZIP code, neighborhood or development name, or other location information. The data that is entered and submitted by the user also includes certain identifying information specific to the user, which can include name, address, telephone number, e-mail address, birth date, Social Security Number, or other identifying information that is specific to that user. Each web page can include one or more fields for the entry of one more of these types of data that the website may request in order for the user to obtain the estimated home value for a property through the home value inquiry submitted by the user through the website. The user may be an individual seeking a mortgage for the purchase of a new home or one who is seeking a refinance mortgage for a home he or she already owns.

Each page of the website in which data is input and submitted by the user can constitute a step of the method. In an exemplary embodiment, when the user uses a computer mouse to click on a web page of the website (e.g., in one of the data entry fields), a pop-under advertisement page. In another embodiment, the advertisement page can be a pop-up advertisement page. The advertisement page can include advertisements such as, for example, a list of mortgage lends and their current rates. Other information may also be provided such as, for example, APR, points for a particular loan, fees, and monthly payment quotes or estimates. The rates may be approximated for the particular location of the home that is the subject of the user's home value inquiry. The advertisement page can also include links to each lender's website, where the user may find additional information concerning a lender's loan product offerings, lender contact information, or online mortgage applications.

By providing the pop-under advertisement (or pop-up or other advertisement), the user, who is already likely to be interested in a mortgage by virtue of checking home values, is almost immediately provided with information about various lenders and their loan terms. In this way, the advertising is more targeted and is more likely to reach person (i.e., the user) who is interested in applying for a mortgage. The information collected from the user during submission of information by the user to obtain the home value estimate can be sold as leads to mortgage lenders. Such leads are more valuable and can be sold for a higher purchase price than leads obtained from other sources in which the interest of each lead (i.e., consumer) in a mortgage may be less well known or entirely unknown. The service provider who provides the services and/or operates the website can also charge more to lenders who advertise their loan products on the advertisement page because, unlike more passive types of online advertising in which an ad appears on a website with the hope that interested consumers will view it, the systems and methods of this invention deliver the ad directly to users of the website conducting home value inquiries. Such individuals are highly likely to be interested in applying for and obtaining a mortgage. The user also benefits because the system provides the user with dynamic information that pertains to available loans and loan details (e.g., rates) that are available in the area in which the property that is the subject of the user's home value inquiry is located.

The invention also relates to a system and method for monetizing Internet traffic related to a home value inquiry. The system includes a website through which a user is directed through a series of pages that request information about a property and about the user's specific needs before providing an estimate of the value of the property. The estimate is provided for purposes of collecting information about the user, which information is sold as leads to mortgage lenders or other service providers (hereafter, “service providers”). By offering to provide a free property value report, the system entices and incentivizes the user to provide certain personal information pertaining to the user that the system requests.

In an exemplary embodiment, the user is asked for a property identifier, which can be a property address and the type of property (e.g., single family home, condominium, etc.). The website also asks the user whether the user is seeking to buy, sell, or refinance the property. Finally, in order to provide a free home value report by e-mail to the user, the system requests the user's name, e-mail address, and phone number. Other information, such as the user's address, income, age, or other demographic information, may also be requested. Upon submitting this information from the website via the Internet to a server, the system sends a home or property value report to the user's e-mail address.

After the system has collected the information of the user, the user information may be sold to service providers as leads, for example, as a lead for a person who may be seeking to purchase a property or who may be seeking a new mortgage.

Most importantly, once the user clicks a control on the website interface to submit the user's information in order to receive the home value report, the system generates a separate pop-under window or a pop-after tab in the browser application. The pop-under or pop-after window, whichever is generated by the system, includes a list of mortgage lenders and their current rates as well as contact information for each lender. The contact information can include a phone number for the lender and/or a link to the lender's website. When the user calls the number provided for a lender in the list or when the user follows the link to the lender's website to submit an online mortgage application, the system notes that the lead for the lender was generated from the system's website so that the website operator may be paid for the lead.

The system can include an address input field that includes an address auto-recognition process connected to an address database so that the system can autocomplete an address being input into the address input field by the user. This feature decreases user errors in which addresses are misspelled or otherwise incorrectly entered into the system by users.

The system can also verify contact information to confirm that the contact information is correct in real-time. For example, the system includes an address-phone number matching process that accesses a database of phone numbers and e-mail addresses that have been verified to belong to the same individual user. By verifying that both the phone number and e-mail address entered into the personal fields of the website by the user are associated with the same individual, the value of the lead is enhanced.

The systems and methods described herein can also provide fair market rental values, and the pop-under or pop-after window can display renter's insurance providers and their rates for insurance for the property identified by the user when submitting the value inquiry through the system.

The systems and methods described herein can also be used to generate and monetize leads for automobile sales, whether new or used, as well as for planes, boats, yachts, other vessels, all-terrain vehicles (ATVs), and other consumer products. For example, the property identifier can be the make and model of an automobile that the user is interested in purchasing or refinancing, and the list of service providers included in the pop-under or pop-after window can include auto lenders and their rates, while the property value report can relate to the value of the automobile identified by the user.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for generating and monetizing a lead based on a value inquiry, the system comprising:
a user information collection process comprising a website for receiving personal information and a property identifier submitted by the user, wherein personal information and the property identifier submitted through the user information collection process by the user is used to create a lead based on a value inquiry related to the property identifier submitted by the user, and wherein the lead comprises the personal information and property identifier submitted by the user through the user information collection process;
a property value report engine for generating a property value report related to the property identifier submitted by the user; and
a window generator script for generating a new window comprising a pop-under window or a pop-after window in an open Internet browser, wherein the new window comprises a list of service providers and contact information for each service provider;
wherein the lead is marketable for sale to a service provider that is one of the service providers on the list of service providers or a different service provider.

2. The system of claim 1, wherein the property identifier comprises a property address, a property legal description, a property's GPS coordinates, a make and model of an automobile, or any other information that identifies the property for which the user is seeking a property value report.

3. The system of claim 1, wherein the new window comprises a different window open in the Internet browser than the window in which the website is displayed.

4. The system of claim 1, wherein the service providers comprise mortgage lenders.

5. The system of claim 1, wherein the new window displays prices or rates for each service provider.

6. The system for generating a lead of claim 5, wherein the service providers comprise mortgage lenders, and wherein the rates comprise mortgage interest rates of the mortgage lenders.

7. The system of claim 1, wherein the personal information comprises the user's name and at least one other item of personal information of the user selected from the group consisting of: a mailing address, a telephone number, or an e-mail address.

8. The system of claim 7, wherein the at least one other item of personal information comprises the user's e-mail address, and wherein the property value report engine transmits a copy of the property value report related to the property identifier submitted by the user to the user's e-mail address.

9. A system for monetizing Internet traffic related to a property value inquiry, the system comprising:
a website comprising:
(a) property fields for entry by a user of a property address and a property type;
(b) a financial field in which the user selects between buy, sell, or refinance options;
(c) personal fields in which name and contact information for the user are entered;
(d) a submit button on the website for submitting the user's data entries in the property, financial, and personal fields to a server that uses the data entries to generate a lead, wherein the lead comprises the data entries submitted by the user;
a database on the server for storing the information received from the user;
an automated report module for generating a property value report for the property address provided by the user through the website and for sending a copy of the property value report to the user via an e-mail to the user's e-mail address provided by the user as contact information in the personal fields; and
a window generator script for generating a new window comprising a pop-under window or a pop-after window in an open Internet browser, wherein the new window comprises a list of one or more mortgage lenders, rates for each lender, and contact information for each lender;
wherein the lead is offered for sale to the one or more mortgage lenders or to other mortgage lenders not included in the list.

10. The system for monetizing Internet traffic related to a property value inquiry of claim 9, wherein the new window comprises a different window open in the Internet browser than the window in which the website is displayed.

11. The system for monetizing Internet traffic related to a property value inquiry of claim 9, wherein the contact information for each lender is a phone number to complete a telephonic mortgage application, and wherein the user's call to the phone number provided for a particular lender in the new window is a lead tracked by the system so that an operator of the system is paid by the mortgage lenders for such leads.

12. The system for monetizing Internet traffic related to a property value inquiry of claim 9, wherein the contact information for each lender is a link to a second website comprising an online mortgage application, and wherein the user's accessing the link provided for a particular lender in the new window is a second lead tracked by the system so that an operator of the system is paid by the mortgage lenders for such leads.

13. The system for monetizing Internet traffic related to a property value inquiry of claim 9, wherein the property type comprises a property type selected from the group consisting of: a single family home, a condominium, a townhome, a cooperative housing unit, a duplex, a timeshare, a commercial building, and raw land; and
wherein the property type further comprises a user selection that identifies the property value inquiry as relating to the user's desire to purchase, refinance, or rent the property.

14. A method for generating a lead, wherein the method comprises the steps of:
(a) providing a website for receiving and transmitting data entries provided by a user, the website comprising:
property fields for entry by the user of a property identifier and a property type;
a financial field in which the user selects between buy, sell, or refinance options; and
personal fields in which name and contact information for the user are entered;
(b) inputting of a user-selected property identifier and property type in the property fields, an option in the financial field, and the user's name and contact information in the personal fields;
(c) submitting the user's data entries to a remote server for storage on a database located on the remote server, wherein the data entries are used by the server to generate a lead that is marketable for sale to a service provider;
(d) using an automated report module, generating a property value report for the property identifier provided by the user through the website;
(e) transmitting a copy of the property value report to the user via an e-mail to the user's e-mail address provided by the user as contact information in the personal fields; and
(f) using a window generator script, generating a new window comprising a pop-under window or a pop-after window in an open Internet browser, wherein the new window comprises a name of at least one service provider, which can include the service provider or one or more different service providers, and contact information for each service provider.

15. The method of claim 14, wherein the at least one service provider comprises at least one mortgage lender.

16. The method of claim 14, wherein the new window displays prices or rates for each at least one service provider.

17. The method of claim 14, wherein the service providers comprise mortgage lenders, and wherein the rates comprise mortgage interest rates of the mortgage lenders.

18. The method of claim 14, wherein the contact information for the at least one service provider comprises a link to a second website and wherein the method further comprises the steps of:
(g) accessing the link to be directed to the second website;
(h) requesting a quote from the at least one service provider.

19. The method of claim 18, wherein the at least one service provider is at least one mortgage lender and step (h) comprises completing an online mortgage application.

20. The method of claim 14, wherein the property identifier comprises a property address, a property legal description, a property's GPS coordinates, a make and model of an automobile, or any other information that identifies the property for which the user is seeking a value report.
